(19) United States
(12) Patent Application Publication
(10) Pub. No.: US 2016/0364245 A1
(43) Pub. Date: Dec. 15, 2016

(54) OPERATION METHOD OF COMMUNICATION NODE IN AUTOMOTIVE NETWORK

(71) Applicant: Hyundai Motor Company, Seoul (KR)

(72) Inventors: Jin Hwa Yun, Seoul (KR); Kang Woon Seo, Seoul (KR); Dong Ok Kim, Goyang (KR)

(21) Appl. No.: 15/155,692

(22) Filed: May 16, 2016

(30) Foreign Application Priority Data
Jun. 11, 2015 (KR) 10-2015-0082621

(51) Int. Cl. G06F 9/44; H04L 12/40; H04L 29/08

(52) U.S. Cl. CPC G06F 9/4416; H04L 67/12; H04L 12/40006; H04L 67/125; H04L 2012/40215

(57) ABSTRACT

An operation method of a communication node including a physical (PHY) layer block and a controller includes: transmitting, by the controller, a wakeup signal for a booting operation of an operating system (OS) in a counterpart communication node to the counterpart communication node through the PHY layer block; determining, by the controller, that the booting operation of the OS in the counterpart communication node is completed; and transmitting, by the controller, data to the counterpart communication node through the PHY layer block after the booting operation of the OS in the counterpart communication node is completed.

### CROSS-REFERENCE TO RELATED APPLICATIONS

This application claims priority to and the benefit of Korean Patent Application No. 10-2015-0082621 filed on Jun. 11, 2015 in the Korean Intellectual Property Office (KIPO), wherein the entire contents of which are hereby incorporated by reference.

### BACKGROUND

### 1. Technical Field

The present disclosure relates generally to communications between nodes in an automotive network, and more particularly, to a technique for preventing data loss in a receiving communication node when data communications are performed between communication nodes.

### 2. Related Art

Along with the rapid digitalization of vehicle parts, the number and variety of electronic devices installed within a vehicle have been increasing significantly. Electronic devices may currently be used in a power train control system, a body control system, a chassis control system, an automotive network, a multimedia system, and the like. The power train control system may include an engine control system, an automatic transmission control system, etc. The body control system may include a body electronic equipment control system, a convenience apparatus control system, a lamp control system, etc. The chassis control system may include a steering apparatus control system, a brake control system, a suspension control system, etc.

Meanwhile, an automotive network may include a controller area network (CAN), a FlexRay-based network, a media oriented system transport (MOST)-based network, etc. The multimedia system may include a navigation apparatus system, a telematics system, an infotainment system, etc.

Such systems and electronic devices constituting each of the systems are connected via the automotive network, which supports functions of the electronic devices. For instance, the CAN may support a transmission rate of up to 1 Mbps and may support auto retransmission of colliding messages, error detection-based on a cyclic redundancy check (CRC), etc. The FlexRay-based network may support a transmission rate of up to 10 Mbps and may support simultaneous transmission of data through two channels, synchronous data transmission, etc. The MOST-based network is a communication network for high-quality multimedia, which may support a transmission rate of up to 150 Mbps.

Meanwhile, the telematics system, the infotainment system, as well as enhanced safety systems of a vehicle require high transmission rates and system expandability. However, the CAN, FlexRay-based network, or the like may not sufficiently support such requirements. The MOST-based network may support a higher transmission rate than the CAN and the FlexRay-based network. However, costs increase to apply the MOST-based network to all automotive networks. Due to these limitations, an Ethernet based network may be considered as an automotive network. The Ethernet-based network may support bi-directional communication through one pair of windings and may support a transmission rate of up to 10 Gbps.

Each communication node constituting the automotive network may include a physical (PHY) layer block configured to perform data or control signal communications with external nodes and a controller configured to perform functions of the communication node. In order to reduce power consumption of the communication node, in some cases only the PHY layer block is activated, and the controller rapidly transitions from an inactivation mode to an activation mode according to a signal received from an external node. The controller may start performing an operating system (OS) booting operation when the PHY layer block receives the data or control signal from the external node. Therefore, the data having been received at the PHY layer block before completion of the OS booting operation in the controller may be lost since the data are received during an inactive mode of the controller.

### SUMMARY

Accordingly, embodiments of the present disclosure are provided to substantially obviate one or more problems due to limitations and disadvantages of the related art. Embodiments of the present disclosure provide operation methods of a communication node, in which the communication node determines whether an operating system (OS) booting operation of a counterpart communication node is completed before transmitting data to the counterpart communication node, and transmits data to the counterpart communication node when it is determined that the OS booting operation of the counterpart communication node is completed.

In accordance with embodiments of the present disclosure, an operation method of a communication node, which includes a physical (PHY) layer block and a controller, includes: including a physical (PHY) layer block and a controller, the method comprising: transmitting, by the controller, a wakeup signal for a booting operation of an operating system (OS) in a counterpart communication node to the counterpart communication node through the PHY layer block; determining, by the controller, that the booting operation of the OS in the counterpart communication node is completed; and transmitting, by the controller, data to the counterpart communication node through the PHY layer block after the booting operation of the OS in the counterpart communication node is completed.

The controller may be connected to the PHY layer block via at least one of a media independent interface (MII), a reduce MII (RMII), a gigabit MII (GMII), a reduced GMII (RGMII), a serial GMII (SGMII), and a 10 GMII (XGMII).

The wakeup signal may be transmitted to the counterpart communication node via at least one of a controller area network (CAN) network, a FlexRay network, a media oriented system transport (MOST) network, a local interconnect network (LIN) network, and an Ethernet network.

The controller may determine that the booting operation of the OS in the counterpart communication node is completed, based on information about a booting time required for the booting operation of the OS in the counterpart communication node.

Also, the information on the booting time may be stored in table-form including identification information corresponding to types of communication nodes and information about booting times for the respective communication nodes corresponding to the identification information.

Also, the determining that the booting operation of the OS in the counterpart communication node is completed may include starting a timer corresponding to the information about the booting time; determining whether the timer is expired; and determining that the booting operation of the OS in the counterpart communication node is completed, when the timer is expired.

The determining that the booting operation of the OS in the counterpart communication node is completed may include receiving a booting completion signal indicating that the booting operation of the OS in the second communication node is completed from the counterpart communication node; and determining that the booting operation of the OS in the counterpart communication node is completed when the booting completion signal is received.

The communication node may be connected to an automotive network.

Furthermore, in accordance with embodiments of the present disclosure, an operation method of a communication node, which includes a physical (PHY) layer block and a controller, includes: receiving, by the controller, a wakeup signal from a counterpart communication node through the PHY layer block; performing, by the controller, a booting operation of an operating system (OS); and receiving, by the controller, data transmitted by the counterpart communication node through the PHY layer block after completion of the booting operation.

The receiving of the data transmitted by the counterpart communication node after completion of the booting operation may be started based on information about a booting time required for the booting operation.

The method may further include: generating a booting completion signal after the completion of the booting operation of the OS; and transmitting the generated booting completion signal to the counterpart communication node. In addition, the receiving of the data transmitted by the counterpart communication node after completion of the booting operation may be started based on the booting completion signal.

The communication node may be connected to an automotive network.

Furthermore, in accordance with embodiments of the present disclosure, a communication node may include a controller and a physical (PHY) layer block. In the communication node, the controller may control the PHY layer block to transmit a wakeup signal for a booting operation of an operating system (OS) in a counterpart communication node to the counterpart communication node, determine that the booting operation of the OS in the counterpart communication node is completed, and control the PHY layer block to transmit data to the counterpart communication node after the booting operation of the OS in the counterpart communication node is completed. The controller may include a storage storing information about a booting time required for the booting operation of the OS in the counterpart communication node, and determine that the booting operation of the OS in the counterpart communication node is completed based on the information about the booting time.

Also, the information on the booting time may be stored in table-form including identification information corresponding to types of communication nodes and information about booting times for the respective communication nodes corresponding to the identification information.

The controller may obtain the information about the booting time of the OS in the counterpart communication node from the storage, start a timer corresponding to the information about the booting time, determine whether the timer is expired, and determine that the booting operation of the OS in the counterpart communication node is completed when the timer is expired.

The controller may determine that the booting operation of the OS in the counterpart communication node is completed when a booting completion signal indicating that the booting operation is completed is received from the counterpart communication node.

Furthermore, in accordance with embodiments of the present disclosure, a communication node may include a controller and a physical (PHY) layer block. In the communication node, the controller may perform a booting operation of an operating system (OS) according to a wakeup signal transmitted from a counterpart communication node, and receive data transmitted from the counterpart communication node after completion of the booting operation. In addition, the PHY layer block may receive the wakeup signal and the data transmitted from the counterpart communication node.

The PHY layer block may start to receive the data from the counterpart communication node based on information about a booting time required for the booting operation.

The controller may generate a booting completion signal after completion of the booting operation of the OS, transmit the generated booting completion signal to the counterpart communication node, and start to receive the data transmitted by the counterpart communication node based on the booting completion signal.

According to the present disclosure, when data communications are performed between communication nodes in an automotive network, data can be transmitted to a receiving communication node after completion of an OS booting operation in the receiving communication node. Therefore, data loss in the receiving communication node can be prevented.

### BRIEF DESCRIPTION OF DRAWINGS

Exemplary embodiments of the present disclosure will become more apparent by describing in detail exemplary embodiments of the present disclosure with reference to the accompanying drawings, in which:

FIG. 1 is a diagram showing an automotive network topology according to embodiments of the present disclosure;

FIG. 2 is a diagram showing a communication node constituting an automotive network according to embodiments of the present disclosure;

FIG. 3 is a flow chart to explain embodiments of an operation method of a communication node according to the present disclosure;

FIG. 4 is a flow chart to explain a step of determining whether an OS booting operation in a counterpart communication node is completed, which is illustrated in FIG. 3, according to embodiments of the present disclosure;

FIG. 5 is a flow chart to explain a step of determining whether an OS booting operation in a counterpart communication node is completed, which is illustrated in FIG. 3, according to embodiments of the present disclosure;

FIG. 6 is a flow chart to explain an operation method of a communication node according to embodiments of the present disclosure;

FIG. 7 is a block diagram of embodiments illustrating network connection relations between communication nodes according to the present disclosure;

FIG. 8 is a block diagram of embodiments illustrating network connection relations between communication nodes according to the present disclosure;

FIG. 9 is a block diagram of embodiments illustrating network connection relations between communication nodes according to the present disclosure; and

FIG. 10 is a block diagram of embodiments illustrating network connection relations between communication nodes according to the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g., fuels derived from resources other than petroleum).

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the controller in conjunction with one or more other components, as would be appreciated by a person of ordinary skill in the art. Further, although embodiments are described herein as using a plurality of units to perform the exemplary process, it is understood that the exemplary processes may also be performed by one or plurality of modules. Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Since the present disclosure may be variously modified and have several embodiments, specific embodiments will be shown in the accompanying drawings and be described in detail in the detailed description. It should be understood, however, that it is not intended to limit the present disclosure to the specific embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without being departed from the scope of the present disclosure and the second component may also be similarly named the first component. The term ‘and/or’ means any one or a combination of a plurality of related and described items.

When it is mentioned that a certain component is “coupled with” or “connected with” another component, it should be understood that the certain component is directly “coupled with” or “connected with” to the other component or a further component may be located therebetween. In contrast, when it is mentioned that a certain component is “directly coupled with” or “directly connected with” another component, it will be understood that a further component is not located therebetween.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Unless otherwise defined, all terms (including technical and scientific terms) used herein have the same meaning as commonly understood by one of ordinary skill in the art to which this disclosure belongs. Terms such as terms that are generally used and have been in dictionaries should be construed as having meanings matched with contextual meanings in the art. In this description, unless defined clearly, terms are not ideally, excessively construed as formal meanings.

Hereinafter, embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted.

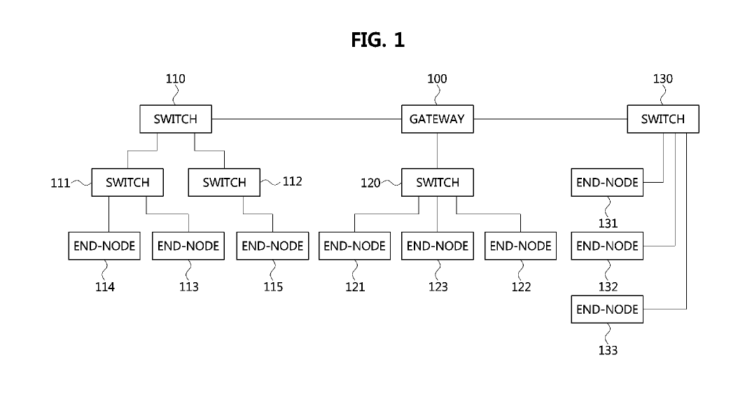

FIG. 1 is a diagram showing an automotive network topology according to embodiments of the present disclosure.

As shown in FIG. 1, a communication node may include a gateway, a switch (or bridge), or an end node. The gateway 100 may be connected with at least one switch 110, 111, 112, 120, and 130 and may be configured to connect different networks. For example, the gateway 100 may connect a switch that supports a controller area network (CAN) (e.g., FlexRay, media oriented system transport (MOST), or local interconnect network (LIN)) protocol and a switch that supports an Ethernet protocol. The switches 110, 111, 112, 120, and 130 may be connected with at least one end nodes 113, 114, 115, 121, 122, 123, 131, 132, and 133. The switches 110, 111, 112, 120, and 130 may interconnect and operate the end nodes 113, 114, 115, 121, 122, 123, 131, 132, and 133.

The end nodes 113, 114, 115, 121, 122, 123, 131, 132, and 133 may include an electronic control unit (ECU) configured to operate various types of devices mounted within a vehicle. For example, the end nodes 113, 114, 115, 121, 122, 123, 131, 132, and 133 may include an ECU configured to operate an infotainment device (e.g., a display device, a navigation device, and an around view monitoring device).

Communication nodes (e.g., a gateway, a switch, an end node, or the like) included in an automotive network may be connected in a star topology, bus topology, ring topology, tree topology, mesh topology, etc. In addition, the communication nodes of the automotive network may support a CAN protocol, FlexRay protocol, MOST protocol, LIN protocol, or Ethernet protocol. Embodiments of the present disclosure may be applied to the above-described network topology. The network topology to which exemplary embodiments of the present disclosure are to be applied is not limited thereto and may be configured in various ways.

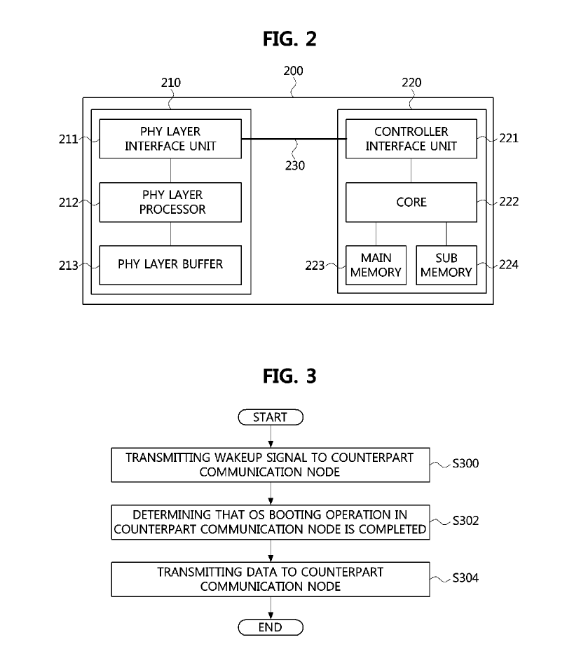

FIG. 2 is a diagram showing a communication node constituting an automotive network according to embodiments of the present disclosure. Notably, the various methods discussed herein below may be executed by a controller having a processor and a memory.

As shown in FIG. 2, a communication node 200 of a network may include a PHY layer block 210 and a controller 220. In particular, the controller 220 may be implemented to include a medium access control (MAC) layer. A PHY layer block 210 may be configured to receive or transmit signals from or to another communication node. The controller 220 may be configured to operate the PHY layer block 210 and perform various functions (e.g., an infotainment function). The PHY layer block 210 and the controller 220 may be implemented as one system on chip (SoC) or alternatively, may be implemented as separate chips.

Further, the PHY layer block 210 and the controller 220 may be connected via a media independent interface (MII) 230. The MII 230 may include an interface defined in the IEEE 802.3 and may include a data interface and a management interface between the PHY layer block 210 and the controller 220. One of a reduced MII (RMII), a gigabit MII (GMII), a reduced GMII (RGMII), a serial GMII (SGMII), a 10 GMII (XGMII) may be used instead of the MII 230. A data interface may include a transmission channel and a reception channel, each of which may have an independent clock, data, and a control signal. The management interface may include a two-signal interface, one signal for the clock and one signal for the data.

Particularly, the PHY layer block 210 may include a PHY layer interface part 211, a PHY layer processor 212, and a PHY layer buffer 213. The configuration of the PHY layer block 210 is not limited thereto, and the PHY layer block 210 may be configured in various ways. The PHY layer interface part 211 may be configured to transmit a signal received from the controller 220 to the PHY layer processor 212 and transmit a signal received from the PHY layer processor 212 to the controller 220. The PHY layer processor 212 may be configured to execute operations of the PHY layer interface part 211 and the PHY layer buffer 213. The PHY layer processor 212 may be configured to modulate a signal to be transmitted or demodulate a received signal. The PHY layer processor 212 may be configured to operate the PHY layer buffer 213 to input or output a signal. The PHY layer buffer 213 may be configured to store the received signal and output the stored signal based on a request from the PHY layer processor 212.

The controller 220 may be configured to monitor and operate the PHY layer block 210 using the MII 230. The controller 220 may include a controller interface part 221, a core 222, a main memory 223, and a sub memory 224. The configuration of the controller 220 is not limited thereto, and the controller 220 may be configured in various ways. The controller interface part 221 may be configured to receive a signal from the PHY layer block 210 (e.g., the PHY layer interface part 211) or an upper layer (not shown), transmit the received signal to the core 222, and transmit the signal received from the core 222 to the PHY layer block 210 or upper layer. The core 222 may further include an independent memory control logic or an integrated memory control logic for operating the controller interface part 221, the main memory 223, and the sub memory 224. The memory control logic may be implemented to be included in the main memory 223 and the sub memory 224 or may be implemented to be included in the core 222.

Furthermore, each of the main memory 223 and the sub memory 224 may be configured to store a signal processed by the core 222 and may be configured to output the stored signal based on a request from the core 222. The main memory 223 may be a volatile memory (e.g., a random access memory (RAM)) configured to temporarily store data required for the operation of the core 222. The sub memory 224 may be a non-volatile memory in which operating system codes (e.g., kernel and device drivers) and an application program code for performing a function of the controller 220 may be stored. A flash memory having a high processing speed or a hard disc drive (HDD) or a compact disc-read only memory (CD-ROM) for large capacity data storage may be used as the non-volatile memory. Typically, the core 222 may include a logic circuit having at least one processing core. A core of an Advanced RISC Machines (ARM) family or a core of an Atom family may be used as the core 222.

A method performed by a communication node and a corresponding counterpart communication node, which belong to an automotive network, will be described below. Although a method (e.g., signal transmission or reception) performed by a first communication node will be described below, a second communication node that corresponds thereto may perform a method (e.g., signal reception or transmission) corresponding to the method performed by the first communication node. In other words, when an operation of the first communication node is described, the second communication node corresponding thereto may be configured to perform an operation that corresponds to the operation of the first communication node. Additionally, when an operation of the second communication node is described, the first communication node may be configured to perform an operation that corresponds to an operation of a switch.

FIG. 3 is a flow chart to explain embodiments of an operation method of a communication node according to the present disclosure.

A controller may transmit a wakeup signal for a booting of an operating system (OS) in a counterpart communication node to the counterpart communication node through a PHY layer block (S300). Here, the wakeup signal is a signal for triggering the booting of the OS in the counterpart communication node.

In order to transmit the wakeup signal, the controller and the PHY layer block are connected to each other via an interface such as a media independent interface (MII), a reduce MII (RMII), a gigabit MII (GMII), a reduced GMII (RGMII), a serial GMII (SGMII), a 10 GMII (XGMII), etc.

Also, in order to transmit the wakeup signal to the counterpart communication node, the PHY layer block is connected with the counterpart communication node through a CAN network, a FlexRay network, a MOST network, a LIN network, an Ethernet network, etc. Also, such the network may have a network topology such as a star topology, a bus topology, a ring topology, a tree topology, a mesh topology, etc. For this, the controller and the PHY layer block may support a CAN protocol, a FlexRay protocol, a MOST protocol, a LIN protocol, or an Ethernet protocol.

Basically, the controller may operate in a doze mode (e.g., inactive mode), and it may be transitioned from the doze mode to an awake mode (e.g., active mode) if necessary. That is, once an event occurs, the controller may transmit the wakeup signal to the counterpart communication node when a channel is idle. Here, the event may be an execution command according to data transmission between the communication nodes.

After the step S300, the controller may determine whether the booting of the OS in the counterpart communication node is completed (S302). Once the wakeup signal is transmitted, the counterpart communication node may perform the booting operation of the OS in response to the wakeup signal. In the booting operation, a controller of the counterpart communication node may load an OS kernel, decompress compressed OS kernel (if necessary), and execute the booting operation by using the OS kernel. Accordingly, initialization and setup of the counterpart communication node may be completed. The controller may determine whether the OS booting operation is completed or not after the OS booting operation is started.

The controller may determine whether the OS booting operation of the counterpart communication node is completed based on information about a time required for the counterpart node to complete the OS booting operation.

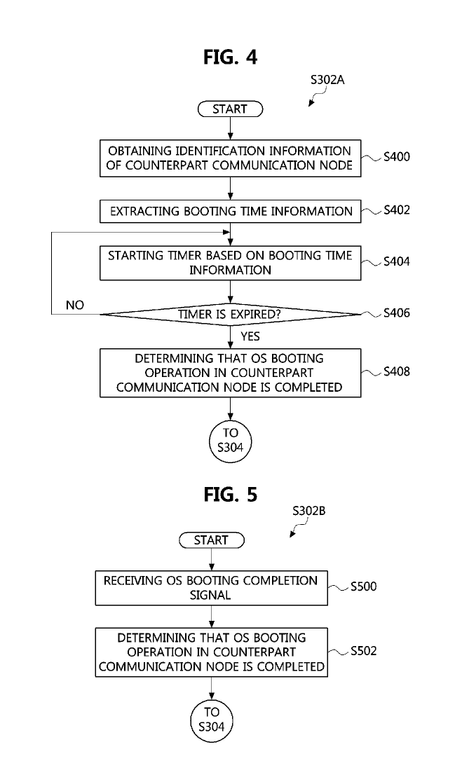

FIG. 4 is a flow chart to explain a step of determining whether an OS booting operation in a counterpart communication node is completed, which is illustrated in FIG. 3, according to embodiments of the present disclosure.

The controller may obtain identification information corresponding to the counterpart communication node (S400). Here, the identification information may be a unique identifier of the counterpart communication node, etc. for discriminating the counterpart communication node from other communication nodes.

After the step S400, the controller may obtain information about the time required for the counterpart communication node to complete the OS booting operation in the counterpart communication node (S402). Hereinafter, the information about the time required for the counterpart communication node to complete the OS booting operation may be referred to as “booting time information.” That is, the “booting time information” may be constructed in a form of a table including identification information corresponding to a type of the counterpart communication node and corresponding time required for completing the OS booting operation. Such the information included in the table may vary according to properties of communication nodes or types of OSs in the communication nodes.

TABLE 1

| | Identification | OS booting |
|---|---|---|
| Communication Node | information | time (ms) |
| Communication node 1 | 0000 | 150 |
| Communication node 2 | 0001 | 160 |
| Communication node 3 | 0010 | 170 |
| Communication node 4 | 0011 | 180 |

. . .

| | | |
|---|---|---|
| Communication node N | . . . | . . . |

The booting time information may be stored previously in a predetermined storage, and the booting time information corresponding to the identification information of the counterpart communication node may be obtained through information query performed by the controller. For example, when the counterpart communication node to which data is transmitted is the communication node 2 represented in the table 1, the controller may extract the OS booting time ‘160 ms’ corresponding to the identification information ‘0001’ of the communication node 2.

Although it was explained that the controller extracts the booting time information in the steps S400 and S402 after transmitting the wakeup signal, a processing sequence for the obtaining of the booting time information may not be restricted thereto. That is, the controller may promptly obtain the booting time information stored in the predetermined storage according to occurrence of the event.

The controller may perform timer operation based on the obtained booting time information (S404). For example, when it is assumed that the counterpart communication node is the communication node 2 in the table 1, the controller may perform timer operation corresponding to the OS booting time 160 ms. For the timer operation, the controller may be configured to include a timer.

After the step S404, the controller may determine whether the OS booting time corresponding to the counterpart communication node elapsed or not (S406). For example, since the obtained OS booting time is 160 ms, the controller may determine whether the OS booting time 160 ms elapsed. Before a lapse of the OS booting time 160 ms, the controller may continue the timer operation in the step S404.

After the step S406, after a lapse of the OS booting time corresponding to the counterpart communication node, the controller may determine that the OS booting operation in the counterpart communication node has been completed (S408).

Meanwhile, although the controller may determine whether the OS booting operation is completed after a lapse of the time defined in the booting time information stored in the storage, the controller may determine whether the OS booting operation in the counterpart communication node is completed or not based on an OS booting completion signal transmitted from the counterpart communication node.

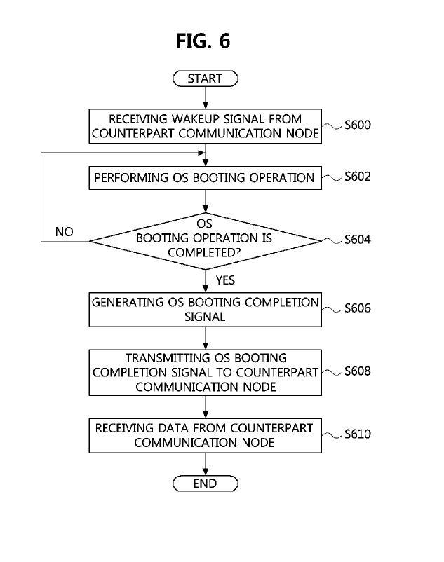

FIG. 5 is a flow chart to explain additional/alternative steps of determining whether an OS booting operation in a counterpart communication node is completed, which is illustrated in FIG. 3, according to embodiments of the present disclosure.

The controller may receive an OS booting completion signal from a counterpart communication node (S500). The OS booting completion signal is a signal transmitted by the counterpart communication node, for indicating that the OS booting operation has been completed. In response to the wakeup signal, the counterpart communication node starts its OS booting operation, generates the OS booting completion signal when the OS booting operation is completed, and transmits the OS booting completion signal to the communication node. The controller may receive the OS booting completion signal from the counterpart communication node via the PHY layer block.

After the step S500, the controller may determine that the OS booting operation in the counterpart communication node has been completed based on the received OS booting completion signal (S502).

After the step S502 (e.g., S302), the controller may transmit data to the counterpart communication node via the PHY layer block (S304). If the OS booting operation is completed, the counterpart communication node may perform operations indicated by an event by using the received data. Accordingly, if the OS booting operation in the counterpart communication node is completed, the controller of the transmitting communication node may transfer data for the operations in the counterpart communication node to the PHY layer block, and the PHY layer block may transmit the data to the counterpart communication node. The data transmitted to the counterpart communication node are stored in a main memory of the counterpart communication node, and the counterpart communication node may perform operations indicated by the event by using the data stored in the main memory.

FIG. 6 is a flow chart to explain an additional/alternative operation method of a communication node according to embodiments of the present disclosure.

The controller may receive a wakeup signal transmitted by the counterpart communication node via the PHY layer block (S600). The PHY layer block may operate always in an awake mode. The PHY layer block may identify whether a signal exists through an energy detection operation. For example, the PHY layer block may determine that a signal exists in a channel through the energy detection operation when a signal having a strength greater than a predetermined threshold is detected. Here, the signal may include both a signal for wakeup (e.g., wakeup signal) and data, or may include only the wakeup signal.

In order to receive the wakeup signal from the counterpart communication node, the PHY layer block may be connected to the counterpart communication node via a CAN network, a FlexRay network, a MOST network, a LIN network, an Ethernet network, etc.

The PHY layer block transfers the received wakeup signal to the controller. For this, the PHY layer block and the controller may be connected via an interface such as MII, RMII, GMII, RGMII, SGMII, XGMII, etc. The wakeup signal is a signal for waking up the controller, and thus it is not necessary that the controller stores the wakeup signal.

After the step S600, the controller may perform its OS booting operation in response to the wakeup signal (S602). Upon receiving the wakeup signal, the controller may load the OS kernel for the OS booting operation, decompress compressed OS kernel (if necessary), and perform the OS booting operation by using the OS kernel.

After the step S602, the controller may determine whether the OS booting operation is completed (S604). If the initialization and setup for the communication node is completed by performing the OS booting operation, the controller may determine that the OS booting operation is completed.

In the step S604, if the OS booting operation is completed, the controller may generate an OS booting completion signal indicating that the OS booting operation is completed (S606). The OS booting completion signal is a signal for the communication node to notify the counterpart communication node that the OS booting operation has been completed.

After the step S606, the controller may transmit the generated OS booting completion signal to the counterpart communication node via the PHY layer block (S608). However, the above-described steps S604, S606, and S608 may not be essential steps for the present disclosure according to various exemplary embodiments. That is, a step S610 which will be explained later will be performed after the step S602, and the steps S604, S606, and S608 may be omitted.

After the step S608, the controller may receive the data transmitted by the counterpart communication node via the PHY layer block (S610). The counterpart communication node may determine whether the OS booting time (e.g., the OS booting time of the receiving communication node including the controller) elapsed. Accordingly, the counterpart communication node may start data transmission after a lapse of the OS booting time. Also, the counterpart communication node may receive the OS booting completion signal from the receiving communication node. That is, the counterpart communication node may start the data transmission to the receiving communication node when the counterpart communication node identifies that the OS booting operation in the receiving communication node has been completed.

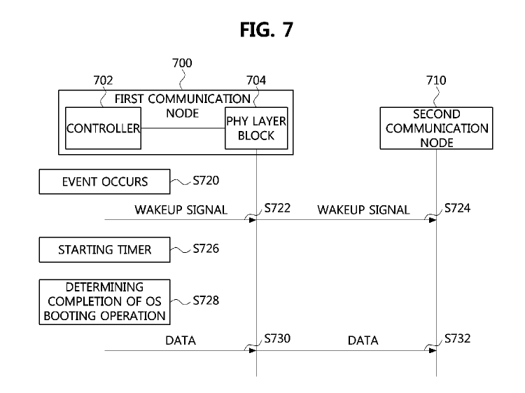

FIG. 7 is a block diagram of embodiments illustrating network connection relations between communication nodes according to the present disclosure. In FIG. 7, a first communication node 700 and a second communication node 710 are connected through a predetermined network. The predetermined network may include a CAN network, a FlexRay network, a MOST network, a LIN network, an Ethernet network, etc. Also, such the network may be constructed in a topology such as a star topology, a bus topology, a ring topology, a tree topology, a mesh topology, etc.

The first communication node 700 may include a controller 702 and a PHY layer block 704. Also, as illustrated in FIG. 2, the controller 702 may include a controller interface part 221, a core 222, a main memory 223, and a sub memory 224. Also, as illustrated in FIG. 2, the PHY layer block 704 may include a PHY layer interface part 211, a PHY layer processor 212, and a PHY layer buffer 213.

The controller 702 may control the PHY layer block 704 to transmit a wakeup signal for an OS booting operation of the second communication node 710. First, when an event occurs (S720), the controller 702 may generate the wakeup signal, and transfer the generated wakeup signal to the PHY layer block 704 (S722). In order to transfer the wakeup signal, the controller 702 and the PHY layer block 710 may be connected through an interface such as MII, RMII, GMII, RGMII, SGMII, XGMII, etc. The PHY layer block 704 may transmit the wakeup signal transferred from the controller 702 to the second communication node 710 via a predetermined network (S724). Accordingly, the second communication node may receive the wakeup signal, and perform its OS booting operation in response to the wakeup signal.

Meanwhile, after the transmission of the wakeup signal, the controller 702 may determine whether the OS booting operation in the second communication node 710 is completed based on booting time information for the OS booting operation in the second communication node 710. The booting time information may be constructed in a form of a table including identification information corresponding to a type of the second communication node and corresponding OS booting time required for completing the OS booting operation in the second communication node. Such the information included in the table may vary according to properties of communication nodes or types of OSs in the communication nodes. The booting time information may be stored previously in a predetermined storage (not depicted). The storage may store data processed by the controller 702, and output stored data according to request of the controller 702. That is, the storage may be configured to include the main memory 223 and the sub memory 224 which are illustrated in FIG. 2. Accordingly, the booting time information may be stored in the sub memory 224 of the storage.

First, the controller 702 may obtain identification information of the second communication node 710. Respective communication nodes can be discriminated by using their identification information such as unique identifiers. In order to retrieve OS booting time corresponding to the identification information of the second communication node 710, the controller may access the storage in which the booting time information (e.g., see table 1) are stored. Then, the controller 702 may obtain the OS booting time corresponding to the second communication node 710 from the storage. Here, the controller 702 may obtain the booting time information after transmitting the wakeup signal, or obtain the booting time information from the storage promptly when the event occurs.

The controller 720 may perform timer operation corresponding to the obtained OS booting time (S726). For the timer operation, the controller 702 may be configured to include a timer. After a lapse of a time corresponding to the obtained OS booting time, the controller 702 may determine that the OS booting operation in the counterpart communication node has been completed (S728). Then, the controller 702 may control the PHY layer block 704 to transmit data to the second communication node 710. The data for event processing are transferred to the PHY layer block 704 under the control of the controller 702 (S730), and the PHY layer block 704 may transmit the transferred data to the second communication node 710 (S732).

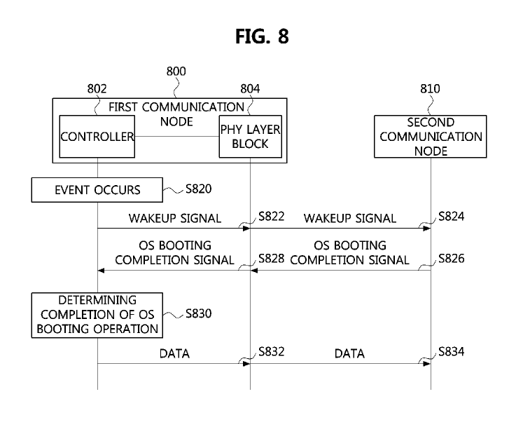

FIG. 8 is a block diagram of embodiments illustrating additional/alternative network connection relations between communication nodes according to the present disclosure. In FIG. 8, a first communication node 800 and a second communication node 810 are connected through a predetermined network. Here, the predetermined network may be same as the predetermined network which connects the first communication node 700 and the second communication node 710 in the exemplary embodiment illustrated in FIG. 7.

The first communication node 800 may include a controller 802 and a PHY layer block 804. Also, as illustrated in FIG. 2, the controller 802 may include a controller interface part 221, a core 222, a main memory 223, and a sub memory 224. Also, as illustrated in FIG. 2, the PHY layer block 804 may include a PHY layer interface part 211, a PHY layer processor 212, and a PHY layer buffer 213.

The controller 802 of the first communication node 800 may control the PHY layer block 804 to transmit a wakeup signal for an OS booting operation of the second communication node 810. When an event occurs (S820), the controller 802 may transfer the wakeup signal to the PHY layer block 804 (S822), and the PHY layer block 804 may transmit the wakeup signal transferred from the controller 802 to the second communication node 810 via a predetermined network (S824). Accordingly, the second communication node 810 may receive the wakeup signal, and perform its OS booting operation in response to the wakeup signal.

After the OS booting operation is completed, the second communication node 810 may generate an OS booting completion signal indicating completion of the OS booting operation, and transmit the OS booting completion signal to the first communication node 800 (S826). The PHY layer block 804 of the first communication node 800 may transfer the received OS booting completion signal to the controller 802 (S828).

The controller 802 may determine that the OS booting operation in the second communication node 810 has been completed based on the OS booting completion signal (S830). Then, the controller 802 may control the PHY layer block 804 to transmit data to the second communication node 810. The controller 820 may transfer the data to be transmitted to the second communication node 810 to the PHY layer block 804. Accordingly, upon receiving the data, the PHY layer block 804 may transmit the data to the second communication node 810 (S834).

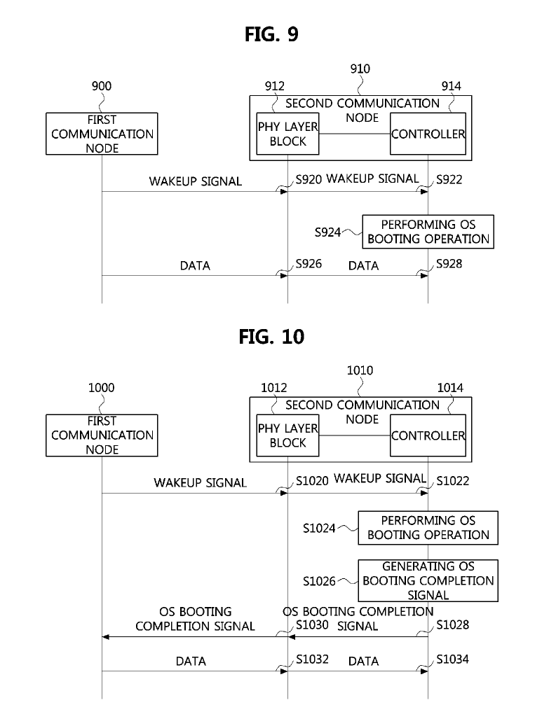

FIG. 9 is a block diagram of embodiments illustrating additional/alternative network connection relations between communication nodes according to the present disclosure. In FIG. 9, a first communication node 900 and a second communication node 910 are connected through a predetermined network. Here, the predetermined network may be same as the predetermined network which connects the first communication node 700 and the second communication node 710 in the exemplary embodiment illustrated in FIG. 7.

The second communication node 920 may include a controller 914 and a PHY layer block 912. Also, as illustrated in FIG. 2, the PHY layer block 912 may include a PHY layer interface part 211, a PHY layer processor 212, and a PHY layer buffer 213. Also, as illustrated in FIG. 2, the controller 914 may include a controller interface part 221, a core 222, a main memory 223, and a sub memory 224.

The first communication node 900 may transmit a wakeup signal for an OS booting operation in the second communication node 910 (S920), and the PHY layer block 912 of the second communication node 910 may receive the transmitted wakeup signal. The PHY layer block 912 may identify whether a signal exists through an energy detection operation. For example, the PHY layer block 912 may determine that a signal exists in a channel through the energy detection operation when a signal stronger than a predetermined threshold is detected. The PHY layer block 912 may transfer the received wakeup signal to the controller 914 (S922). Upon receiving the wakeup signal, the controller 914 may perform the OS booting operation of the second communication node 910 in response to the wakeup signal (S924).

Meanwhile, after the transmission of the wakeup signal, the first communication node 900 may perform a timer operation based on the OS booting time of the second communication node 910, and transmit data to the second communication node 910 after a lapse of a time corresponding to the OS booting time (S926).

Upon receiving the data from the first communication node 900, the PHY layer 912 may transfer the received data to the controller 914 (S928). The data transferred from the PHY layer block 912 may be stored in a storage of the controller 914 (e.g., the main memory 223 illustrated in FIG. 2). Then, the controller 914 may perform operations indicated by an event by using the data stored in the main memory 223.

FIG. 10 is a block diagram of embodiments illustrating additional/alternative network connection relations between communication nodes according to the present disclosure. In FIG. 10, a first communication node 1000 and a second communication node 1010 are connected through a predetermined network. Here, the predetermined network may be same as the predetermined network which connects the first communication node 700 and the second communication node 710 in the exemplary embodiment illustrated in FIG. 7.

The second communication node 1010 may include a controller 1014 and a PHY layer block 1012. Also, as illustrated in FIG. 2, the PHY layer block 1012 may include a PHY layer interface part 211, a PHY layer processor 212, and a PHY layer buffer 213. Also, as illustrated in FIG. 2, the controller 1014 may include a controller interface part 221, a core 222, a main memory 223, and a sub memory 224.

The first communication node 1000 may transmit a wakeup signal for an OS booting operation in the second communication node 1010 (S1020), and the PHY layer block 1012 of the second communication node 1010 may transfer the received wakeup signal to the controller 1014 (S1022). Upon receiving the wakeup signal, the controller 1014 may perform the OS booting operation of the second communication node 1010 in response to the wakeup signal (S1024). That is, the controller 1014 may load OS kernels for the OS booting operation, decompress compressed OS kernels (if necessary), and perform the OS booting operation by using the OS kernels. Then, the controller 1014 may determine whether the OS booting operation has been completed. If the initialization and setup of the communication node is completed by performing the OS booting operation, the controller 1014 may determine that the OS booting operation has been completed. When the OS booting operation is completed, the controller 1014 may generate an OS booting completion signal (S1026). The OS booting completion signal is a signal notifying the first communication node 1000 that the OS booting operation in the second communication node 1010 has been completed. The controller 1014 may transfer the generated OS booting completion signal to the PHY layer block 1012 (S1028), and the PHY layer block 1012 may transmit the OS booting completion signal to the first communication node 1000 (S1030).

According to reception of the OS booting completion signal, the first communication node 1000 may determine that the OS booting operation in the second communication node 1010 has been completed, and transmit data to the second communication node 1010 (S1032). The PHY layer block 1012 of the second communication node 1010 may receive the data transmitted from the first communication node 1000, and transfer the data to the controller 1014 (S1034). The data transferred from the PHY layer block 1012 may be stored in a storage of the controller 1014 (e.g., the main memory 223 illustrated in FIG. 2). After then, the controller 1014 may perform operations indicated by the occurred event by using the data in the main memory 223.

The methods according to embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the operation of the present disclosure, and vice versa.

While the embodiments of the present disclosure and their advantages have been described in detail, it should be understood that various changes, substitutions and alterations may be made herein without departing from the scope of the disclosure.

What is claimed is:

1. An operation method of a communication node including a physical (PHY) layer block and a controller, the method comprising:
transmitting, by the controller, a wakeup signal for a booting operation of an operating system (OS) in a counterpart communication node to the counterpart communication node through the PHY layer block;
determining, by the controller, that the booting operation of the OS in the counterpart communication node is completed; and
transmitting, by the controller, data to the counterpart communication node through the PHY layer block after the booting operation of the OS in the counterpart communication node is completed.

2. The operation method according to claim 1, wherein the controller is connected to the PHY layer block via at least one of: a media independent interface (MII), a reduce MII (RMII), a gigabit MII (GMII), a reduced GMII (RGMII), a serial GMII (SGMII), and a 10 GMII (XGMII).

3. The operation method according to claim 1, further comprising transmitting, by the controller, the wakeup signal to the counterpart communication node via at least one of: a controller area network (CAN) network, a FlexRay network, a media oriented system transport (MOST) network, a local interconnect network (LIN) network, and an Ethernet network.

4. The operation method according to claim 1, further comprising determining, by the controller, that the booting operation of the OS in the counterpart communication node is completed based on information about a booting time required for the booting operation of the OS in the counterpart communication node.

5. The operation method according to claim 4, wherein the information about the booting time is stored in a table-form including identification information corresponding to types of communication nodes and information about booting times for the respective communication nodes corresponding to the identification information.

6. The operation method according to claim 4, wherein the determining that the booting operation of the OS in the counterpart communication node is completed comprises:
starting a timer corresponding to the information about the booting time;
determining whether the timer is expired; and
determining that the booting operation of the OS in the counterpart communication node is completed when the timer is expired.

7. The operation method according to claim 1, wherein the determining that the booting operation of the OS in the counterpart communication node is completed comprises:
receiving a booting completion signal indicating that the booting operation of the OS in the counterpart communication node is completed from the counterpart communication node; and
determining that the booting operation of the OS in the counterpart communication node is completed when the booting completion signal is received.

8. The operation method according to claim 1, wherein the communication node is connected to an automotive network.

9. An operation method of a communication node including a physical (PHY) layer block and a controller, the method comprising:
receiving, by the controller, a wakeup signal from a counterpart communication node through the PHY layer block;
performing, by the controller, a booting operation of an operating system (OS); and
receiving, by the controller, data transmitted by the counterpart communication node through the PHY layer block after completion of the booting operation.

10. The operation method according to claim 9, wherein the receiving of the data transmitted by the counterpart communication node after completion of the booting operation is started based on information about a booting time required for the booting operation.

11. The operation method according to claim 9, further comprising:
generating a booting completion signal after the completion of the booting operation of the OS; and
transmitting the generated booting completion signal to the counterpart communication node,
wherein the receiving of the data transmitted by the counterpart communication node after completion of the booting operation is started based on the booting completion signal.

12. The operation method according to claim 9, wherein the communication node is connected to an automotive network.

13. A communication node comprising:
a controller; and
a physical (PHY) layer block,
wherein the controller controls the PHY layer block to transmit a wakeup signal for a booting operation of an operating system (OS) in a counterpart communication node to the counterpart communication node, determines that the booting operation of the OS in the counterpart communication node is completed, and controls the PHY layer block to transmit data to the counterpart communication node after the booting operation of the OS in the counterpart communication node is completed.

14. The communication node according to claim 13, wherein the controller includes a storage storing information about a booting time required for the booting operation of the OS in the counterpart communication node, and determines that the booting operation of the OS in the counterpart communication node is completed based on the information about the booting time.

15. The communication node according to claim 14, wherein the information about the booting time is stored in table-form including identification information corresponding to types of communication nodes and information about booting times for the respective communication nodes corresponding to the identification information.

16. The communication node according to claim 14, wherein the controller obtains the information about the booting time of the OS in the counterpart communication node from the storage, starts a timer corresponding to the information about the booting time, determines whether the timer is expired, and determines that the booting operation of the OS in the counterpart communication node is completed when the timer is expired.

17. The communication node according to claim 14, wherein the controller determines that the booting operation of the OS in the counterpart communication node is completed when a booting completion signal indicating that the booting operation is completed is received from the counterpart communication node.

18. A communication node comprising:
a controller; and
a physical (PHY) layer block,
wherein the controller performs a booting operation of an operating system (OS) according to a wakeup signal transmitted from a counterpart communication node, and receives data transmitted from the counterpart communication node after completion of the booting operation, and
wherein the PHY layer block receives the wakeup signal and the data transmitted from the counterpart communication node.

19. The communication node according to claim 18, wherein the PHY layer block starts to receive the data from the counterpart communication node based on information about a booting time required for the booting operation.

20. The communication node according to claim 18, wherein the controller generates a booting completion signal after completion of the booting operation of the OS, transmits the generated booting completion signal to the counterpart communication node, and starts to receive the data transmitted by the counterpart communication node based on the booting completion signal.
